(19) United States
(12) Patent Application Publication
(10) Pub. No.: US 2010/0051392 A1
(43) Pub. Date: Mar. 4, 2010

(54) ELEVATOR PIT BARRIER

(76) Inventor: Hanspeter Bloch, Buchrain (CH)

Correspondence Address: SCHWEITZER CORNMAN GROSS & BONDELL LLP, 292 MADISON AVENUE - 19th FLOOR, NEW YORK, NY, 10017, US

(21) Appl. No.: 12/614,717

(22) Filed: Nov. 9, 2009

Related U.S. Application Data
(62) Division of application No. 11/866,634, filed on Oct. 3, 2007.

(30) Foreign Application Priority Data
Oct. 6, 2006 (EP) 06 121879.8

(51) Int. Cl. B66B 13/24; B66B 13/28

(52) U.S. Cl. 187/400

(57) ABSTRACT

An elevator installation includes a car within a shaft, a buffer mounted in a pit of the shaft and a barrier located in the pit surrounding or within an area wherein a vertical clearance between the pit floor and the car or equipment mounted thereon is less than a regulatory threshold value when the car fully compresses the buffer. The barrier acts to physically deter personnel within the pit from inadvertent presence in the area of reduced vertical clearance.

The present invention relates to elevators and, in particular, to a barrier located in an elevator pit to maintain the safety of personnel working in a pit of reduced depth.

### BACKGROUND OF THE INVENTION

There are increasing pressures on the elevator industry to reduce the space occupied by elevator installations within buildings. One solution is to reduce the depth of the pit of the elevator shaft, however, regulations such as European Standard EN81-1:1998 specify that when an elevator car rests on its fully compressed buffers, there shall be a specified minimum free vertical clearance between the pit floor and the lowest parts of the car. There are exceptions to these rules, such as for toeguards, roller guides, guide shoes and safety gear, all of which are generally mounted on the outside periphery of the car. A common situation is depicted in FIGS. 1 to 3. In this example, the elevator car 1 is supported by means of an underslung pulley box 2 on ropes 4. The ropes 4 are driven by a traction sheave (not shown) to move the car 1 along guide rails (not shown) mounted to opposing shaft walls 6. A buffer 16 is mounted in the pit 12 of the shaft 10 to arrest the car 1 should it travel beyond its normal travel limit (e.g. the lowest landing). When the car 1 rests on the fully compressed buffer 16, as shown specifically in FIG. 3, a minimum free vertical clearance C exists between the pit floor 14 and the lowest part of the car 1, which in this instance is the pulley box 2. Although the toeguard 8 actually extends below the pulley box 2, as mentioned above, the regulations allow it to be excluded from consideration.

The objective of the present invention is to reduce the pit depth and thereby the minimum free vertical clearance between the pit floor and the lowest parts of the car while maintaining the safety of any personnel working in the pit.

### BRIEF DESCRIPTION OF THE INVENTION

This objective is achieved by an elevator installation comprising a car within a shaft, a buffer mounted in a pit of the shaft and a barrier located in the pit surrounding or within an area wherein a vertical clearance between the pit floor and the car or equipment mounted thereon is less than a regulatory threshold value when the car fully compresses the buffer. Accordingly, the barrier acts to physically deter personnel within the pit from inadvertent presence in the area of reduced vertical clearance.

Preferably, the barrier is height-adjustable and biased to its highest position. Thus, the barrier can have a height greater than the reduced vertical clearance but will not be damaged if the car travels into it. Furthermore, even if a maintenance person were to get a hand, for example. trapped between the car and the barrier, the height-adjustability of barrier ensures that such entrapment will not cause personal injury.

The barrier may be flexible and preferably elastically deformable. Such a barrier may take the form of an inflated balloon.

Alternatively, the flexible and deformable barrier may comprise two flexible uprights interconnected by linkage means such as a net. Should the car descend into the barrier, the flexible uprights will automatically deform to a reduced height. Since this barrier contains no complicated moving parts it provides a relatively low cost solution.

Preferably, the flexible uprights are formed from doubled-over elements so that if the car descends into the barrier each upright deforms outwards in mutually opposing directions. Accordingly, the greater the deformation of the uprights, the greater the area effectively protected by the barrier.

Alternatively, the barrier may comprise a pair of channels each retaining at least one slider, and linkage means secured to and interconnecting the sliders of the opposing channels. Accordingly, if the car descends into the barrier, the linkage means and sliders moved downwards in the channels against the biasing force.

The linkage means may have the form of rigid bars, wires, belts or a net.

### BRIEF DESCRIPTION OF THE DRAWINGS

The present invention is hereinafter described by way of specific examples with reference to the accompanying drawings in which:

FIG. 1 is a partial, rear diagrammatic elevation view of a pit of an elevator installation according to the prior art:

FIG. 2 is a partial, side diagrammatic elevation view of the pit of FIG. 1;

FIG. 3 is an elevation view corresponding to FIG. 2, illustrating the elevator car compressing the buffer:

FIG. 4 is a partial, rear diagrammatic elevation view of a pit of an elevator installation in accordance with a first embodiment of the present invention;

FIG. 5 is a partial, side elevation view of the pit of FIG. 4;

FIG. 6 is a partial, side elevation view of a pit of an elevator installation in accordance with a second embodiment of the present invention;

FIG. 7 is a view corresponding to FIG. 6 illustrating the elevator car engaging the barrier;

FIG. 8 is a view corresponding to FIG. 6 illustrating the elevator car compressing the buffer:

FIG. 9 is an elevation view of a barrier according to a third embodiment of the invention;

FIG. 10 is an exploded perspective view of the barrier of FIG. 9; and

FIG. 11 is an illustrative sectional view of a barrier according to a fourth embodiment of the invention.

### DETAILED DESCRIPTION OF THE INVENTION

In the following description, for the avoidance of unnecessary repetition, features of the invention which are common to more than one embodiment have been assigned a common reference numeral and where appropriate share a common description.

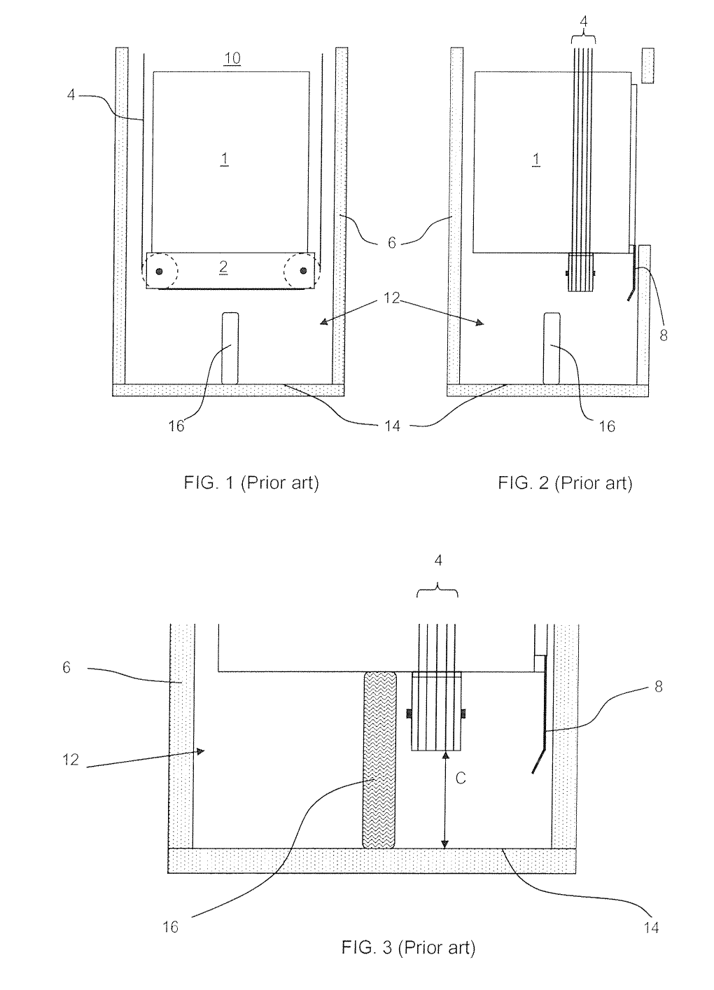

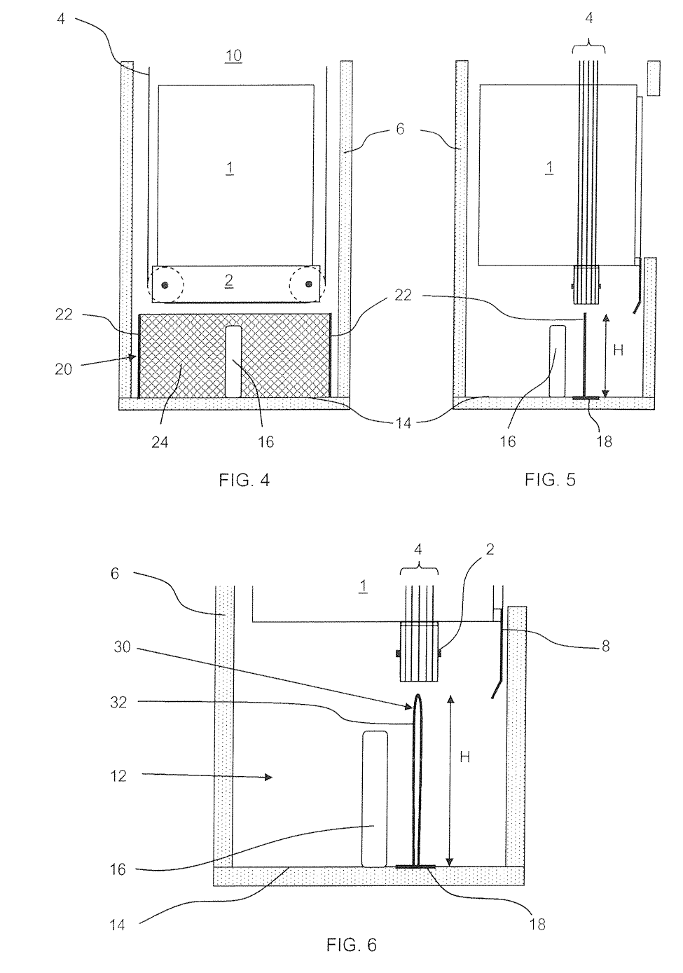

FIGS. 4 and 5 illustrate an elevator installation according to a first embodiment of the present invention. While the arrangements of the car 1 within the shaft 10 are identical to those previously described with respect to the prior art of FIGS. 1 and 2 respectively, areas on the pit floor 14 directly beneath the underslung pulley box 2 or other components mounted under the car are clearly designated as such as being marked with a tape 18 of diagonal stripes of contrasting colours (e.g. yellow and black or red and white). Preferably, words such as “DANGER LOW CLEARANCE” can be printed in the tape 18. Furthermore, a barrier 20 is also erected in the pit 12 directly beneath the underslung pulley box 2. The barrier 20 comprises a pair of opposing flexible uprights 22 mounted to the pit floor 14 with an interconnecting net 24. Accordingly, when maintenance personnel are in the pit 12, the tape 18 and the barrier 20 both act as visible warnings that the area under the pulley box 2 could potentially have a reduced vertical clearance. Moreover, the barrier 20 acts to physically deterrent personnel within the pit 12 from inadvertently working in the area of reduced vertical clearance.

If at any time the pulley box 2 should come into engagement with the barrier 20, the barrier 20 will be deflected due to the flexible nature of the uprights 22. Hence, even if a maintenance person were to get a hand, for example, trapped between the pulley box 2 and the barrier 20, the barrier is sufficiently flexible to accommodate the body part without causing damage.

Given the potential central location of the barrier 20 and the fact that it may essentially span the entire width of the pit 12, the maintenance personnel will inherently need to cross the barrier 20 occasionally; the barrier 20 is easily deformable to enable them to do so. However, these transitions across the barrier 20 make up only a small amount of the total time the maintenance personnel spend in the pit 12. The large majority of maintenance operations carried out in the pit 12 will actually typically require the person to face away from the barrier 20 which in turn generally means that their arms will also be projecting away from the barrier 20, in which case the person will only come into contact with the barrier if he backs into it; the normal reaction to that is to step slightly away and out of the reduced clearance area. Even the majority of work on a pulley box 2 is carried out from the side rather than underneath. Hence, a relatively low barrier, perhaps at knee height (≈500 mm), would be sufficient to effectively deter personnel from inadvertent presence in the area under the pulley box 2.

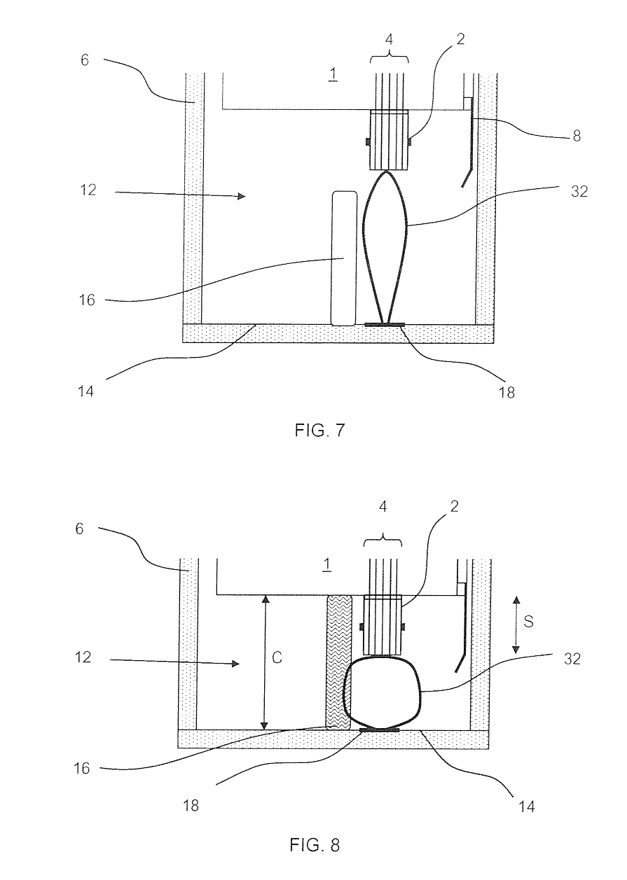

FIGS. 6 to 8 illustrate an alternative barrier 30 which is similar to the barrier 20 of the first embodiment but, in this instance, each of the uprights 32 is formed with a folded or doubled-over element with both ends secured to the pit floor 14. The doubled-over uprights may be sealed along the edges to form balloons. As shown specifically in FIG. 7, as the pulley box 2 descends upon the barrier 30, the doubled-over uprights 32 and the interconnected net 24 are deflected outwards. Accordingly, any person standing adjacent to the barrier 30 is also thrust away from the reduced clearance area under the pulley box 2. The car may continue to descend, and thereby further deform the barrier 30 until it rests on the fully compressed buffer 16, as shown in FIG. 8.

Since the barriers 20,30 of both embodiments effectively deter personnel from inadvertent presence in the area under the pulley box 2, the regulatory minimum free vertical clearance C may now be determined as existing between the pit floor 14 and the car 1, rather then between the pit floor 14 and the underslung pulley box 2 (as in the prior art of FIG. 3), enabling a space saving within the elevator installation corresponding to the height S of the pulley box 2.

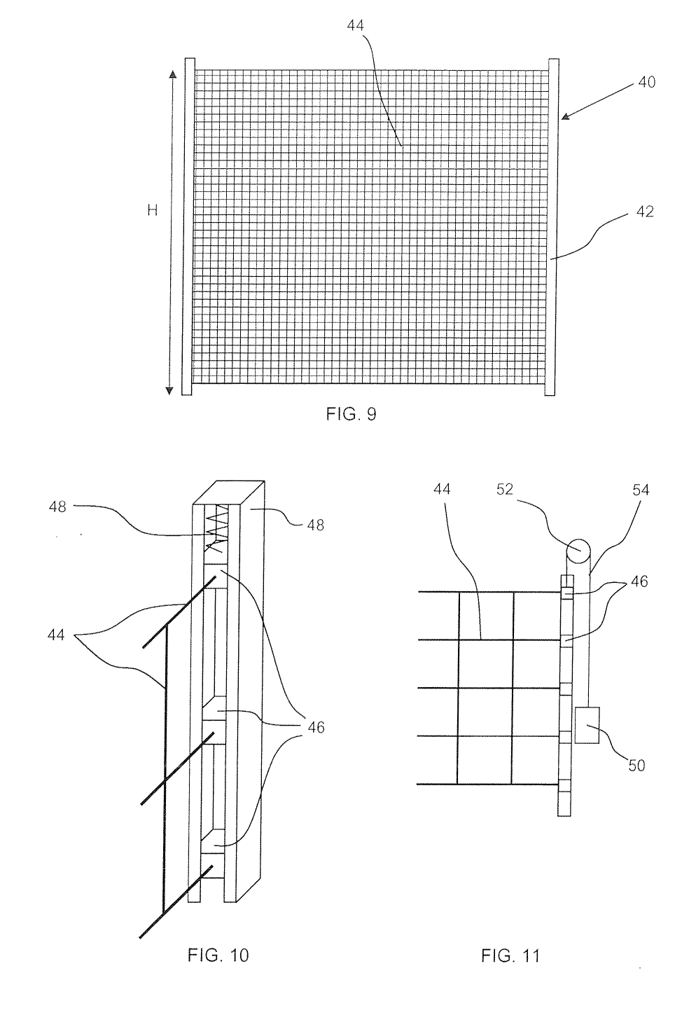

A further embodiment of the invention is illustrated in FIGS. 9 and 10. In this embodiment, the barrier 40 comprises a pair of opposing uprights in the form of U-shaped channels 42. The channels 42 may be secured at their bases to the pit floor 14 as in the previously described embodiments, or, alternatively, they can be mounted on opposing side walls 6 of the shaft 10. Each channel 42 retains a plurality of sliders 46 connected to a net 44. The uppermost slider 46 in each channel 42 is biased upwards by a spring 48.

If at any time the pulley box 2 descends into the net 44, the net 44 will descend therewith against the biasing force of the spring 48.

FIG. 11 shows another alternative embodiment of the invention, wherein the upward bias of the net 44 is provided by a counterweight 50. The uppermost slider 46 within each channel 42 is attached by a wire or rope 54, which passes over a pulley 52 to the counterweight 50.

Although all of embodiments above describe the use of a barrier under the underslung pulley box 2, it will be appreciated that the barrier can be used to deter personnel from inadvertent presence in any area of the pit 12 which has the possibility of reduced clearance.

As previously described, the area under the pulley box 2 is a relatively maintenance intensive area. If, on the other hand, the reduced clearance area is within a high maintenance intensive sector of the pit 12, then a relatively high barrier, perhaps at shoulder height (≈1500 mm), should be employed in or surrounding the reduced clearance area to positively prevent personnel from inadvertent presence in that area.

If the person needs to specifically work in a designated reduced clearance area, he can easily collapse the barrier to do so.

Although a net 24, 44 has been used in the preferred embodiments to interconnect the uprights 22,32 or the channels 48, will be readily appreciated that this can easily be replaced by other linkage means such as wires or rods.

1-10. (canceled)

11. A method for restraining personnel from entering an area of potential reduced vertical clearance between a pit floor in an elevator pit and an elevator car, comprising the steps of:
establishing a minimum required vertical clearance between the pit floor and a lowest part of the elevator car when a compressible buffer of a buffer system in the elevator pit is fully compressed by the elevator car;
determining an area of the pit floor wherein the vertical clearance is less than the minimum required vertical clearance when the compressible buffer is fully compressed; and
selectively erecting a barrier separate from the buffer system at a location spaced from the buffer system to physically deter personnel within the pit and outside the area from inadvertently entering the area.

12. The method of claim 11 wherein the barrier is height-adjustable, further including the step of biasing the barrier to a highest position when erected.

13. The method of claim 12 wherein the erecting step includes locating the barrier at a location within the area that provides for contact between the barrier and the lowest part of the elevator car as the elevator car descends.

14. The method of claim 12 wherein the barrier highest position is greater than the minimum required vertical clearance.

15. The method of claim 13 wherein the barrier highest position is greater than the minimum required vertical clearance.

16. The method of claim 14 wherein the biasing permits the height of the barrier to be reduced by a force applied by the elevator car in a manner that is not injurious to a portion of the human body positioned between the barrier and elevator car.

17. The method of claim 15 wherein the biasing permits the height of the barrier to be reduced by a force applied by the elevator car in a manner that is not injurious to a portion of the human body positioned between the barrier and elevator car.

18. The method of claim 11 further including the step of deforming the barrier outwardly from the area upon contact with the elevator car.

19. The method of claim 18 wherein the deformation step occurs in two mutually opposed directions.

20. The method of claim 18 wherein the extent of outward deformation is inversely proportional to the height of the contacting elevator car above the pit floor.

21. The method of claim 18 wherein a height of the barrier where deformation commences is chosen to be above the minimum required vertical clearance.

22. The method of claim 12 wherein the barrier highest position is less than the minimum required vertical distance.

23. The method of claim 11 further comprising the step of prominently providing a visual marker on the pit floor within the area.

24. The method of claim 23 wherein the marker is provided directly below the lowest part of the elevator car.
